(19) United States
(12) Patent Application Publication
(10) Pub. No.: US 2026/0202828 A1
(43) Pub. Date: Jul. 16, 2026

(54) SYSTEMS, APPARATUSES, METHODS, AND COMPUTER PROGRAM PRODUCTS FOR INITIATING PERFORMANCE OF ONE OR MORE COMPONENT RECONFIGURATION ACTIONS

(71) Applicant: HONEYWELL INTERNATIONAL INC., Charlotte, NC (US)

(72) Inventors: Ananda Vel Murugan Chandra MOHAN, Madurai (IN); Sunil BARDESKAR, Bangalore (IN); Douglas BIRD, Little Canada, MN (US); Ivan Borastero VILLAN, Paris (FR); Chandrashekar SRINIVAS, Bangalore (IN)

(21) Appl. No.: 19/066,551

(22) Filed: Feb. 28, 2025

(30) Foreign Application Priority Data
Jan. 10, 2025 (IN) 202511002447

(51) Int. Cl. G05B 19/418

(52) U.S. Cl. CPC G05B 19/41845; G05B 2219/33125

(57) ABSTRACT

A method provided herein includes identifying a component set from component configuration data. In some embodiments, the method includes retrieving a component feature set. In some embodiments, the component feature set comprises one or more component features corresponding to a component configuration type. In some embodiments, the method includes generating a first clustering parameter set comprising a first subset of the component feature set. In some embodiments, the method includes generating, using the first clustering parameter set and a clustering model, a component cluster comprising a subset of the component set. In some embodiments, the method includes generating, using a component reconfiguration model, component reconfiguration data for the component cluster. In some embodiments, the method includes initiating performance of one or more component reconfiguration actions based on the component reconfiguration data.

### CROSS REFERENCE TO RELATED APPLICATIONS

This application claims the benefit of India Provisional Patent Application No. 202511002447, filed January 10, 2025, the entire contents of which are incorporated by reference herein.

### TECHNOLOGICAL FIELD

Embodiments of the present disclosure relate generally to systems, apparatuses, methods, and computer program products for initiating performance of one or more component reconfiguration actions.

### BACKGROUND

Applicant has identified many technical challenges and difficulties associated with systems, apparatuses, methods, and computer program products for component reconfiguration. Through applied effort, ingenuity, and innovation, Applicant has solved problems related to systems, apparatuses, methods, and computer program products for component reconfiguration by developing solutions embodied in the present disclosure, which are described in detail below.

Various embodiments described herein relate to systems, apparatuses, methods, and computer program products for initiating performance of one or more component reconfiguration actions.

In accordance with one aspect of the disclosure, a method is provided. In some embodiments, the method includes identifying a component set from component configuration data. In some embodiments, the component set comprises one or more components. In some embodiments, the method includes retrieving a component feature set. In some embodiments, the component feature set comprises one or more component features corresponding to a component configuration type. In some embodiments, the method includes generating a first clustering parameter set comprising a first subset of the component feature set. In some embodiments generating the first clustering parameter set comprises identifying one or more key component features in the component feature set. In some embodiments generating the first clustering parameter set comprises applying a key clustering unit to at least one of the one or more key component features in the component feature set. In some embodiments, the method includes generating, using the first clustering parameter set and a clustering model, a component cluster comprising a subset of the component set. In some embodiments, the method includes generating, using a component reconfiguration model, component reconfiguration data for the component cluster. In some embodiments, the method includes initiating performance of one or more component reconfiguration actions based on the component reconfiguration data.

In some embodiments, the method includes generating a second clustering parameter set comprising a second subset of the component feature set.

In some embodiments, generating the second clustering parameter set comprises includes identifying one or more secondary component features in the component feature set.

In some embodiments, generating the second clustering parameter set comprises includes applying a secondary clustering unit to at least one of the one or more secondary component features in the component feature set.

In some embodiments, the one or more secondary component features comprise at least one of an enclosure component feature, a peripheral component feature, or an operating component feature.

In some embodiments, the component cluster is generated using the second clustering parameter set.

In some embodiments, a first portion of the component feature set is retrieved from an internal component feature database and a second portion of the component feature set is retrieved from an external component feature database.

In some embodiments, the clustering model and the component reconfiguration model communicate via a bus of a staged model pipeline.

In some embodiments, the method includes identifying implementation data for the component reconfiguration data.

In some embodiments, the method includes determining an impact value associated with the component reconfiguration data based on the implementation data.

In some embodiments, the method includes in response to the impact value being below an impact value threshold, initiating performance of the one or more component reconfiguration actions.

In some embodiments, initiating performance of the one or more component reconfiguration actions comprises generating a component reconfiguration interface component.

In some embodiments, the component reconfiguration interface component comprises the component reconfiguration data, implementation data, or a visual representation of at least one component of the component cluster.

In some embodiments, initiating performance of the one or more component reconfiguration actions comprises causing the component reconfiguration interface component to be rendered to a component reconfiguration interface.

In some embodiments, initiating performance of the one or more component reconfiguration actions comprises causing a component inventory record to be updated.

In some embodiments, initiating performance of the one or more component reconfiguration actions comprises transmitting a component reconfiguration instruction to a computing device.

In some embodiments, initiating performance of the one or more component reconfiguration actions comprises causing an item manufacturing procedure to be modified.

In accordance with another aspect of the disclosure, an apparatus is provided. In some embodiments, the apparatus includes memory and one or more processors communicatively coupled to the memory. In some embodiments, the one or more processors are configured to identify a component set from component configuration data. In some embodiments, the component set comprises one or more components. In some embodiments, the one or more processors are configured to retrieve a component feature set. In some embodiments, the component feature set comprises one or more component features corresponding to a component configuration type. In some embodiments, the one or more processors are configured to generate a first clustering parameter set comprising a first subset of the component feature set. In some embodiments generating the first clustering parameter set comprises identifying one or more key component features in the component feature set. In some embodiments generating the first clustering parameter set comprises applying a key clustering unit to at least one of the one or more key component features in the component feature set. In some embodiments, the one or more processors are configured to generate, using the first clustering parameter set and a clustering model, a component cluster comprising a subset of the component set. In some embodiments, the one or more processors are configured to generate, using a component reconfiguration model, component reconfiguration data for the component cluster. In some embodiments, the one or more processors are configured to initiate performance of one or more component reconfiguration actions based on the component reconfiguration data.

In some embodiments, the one or more processors are further configured generate a second clustering parameter set comprising a second subset of the component feature set.

In some embodiments, generating the second clustering parameter set comprises includes identifying one or more secondary component features in the component feature set.

In some embodiments, generating the second clustering parameter set comprises includes applying a secondary clustering unit to at least one of the one or more secondary component features in the component feature set.

In some embodiments, the one or more secondary component features comprise at least one of an enclosure component feature, a peripheral component feature, or an operating component feature.

In some embodiments, the component cluster is generated using the second clustering parameter set.

In some embodiments, a first portion of the component feature set is retrieved from an internal component feature database and a second portion of the component feature set is retrieved from an external component feature database.

In some embodiments, the clustering model and the component reconfiguration model communicate via a bus of a staged model pipeline.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for identifying a component set from component configuration data. In some embodiments, the component set comprises one or more components. In some embodiments, the computer program code, in execution with at least one processor, configures the computer program product for retrieving a component feature set. In some embodiments, the component feature set comprises one or more component features corresponding to a component configuration type. In some embodiments, the computer program code, in execution with at least one processor, configures the computer program product for generating a first clustering parameter set comprising a first subset of the component feature set. In some embodiments generating the first clustering parameter set comprises identifying one or more key component features in the component feature set. In some embodiments generating the first clustering parameter set comprises applying a key clustering unit to at least one of the one or more key component features in the component feature set. In some embodiments, the computer program code, in execution with at least one processor, configures the computer program product for generating, using the first clustering parameter set and a clustering model, a component cluster comprising a subset of the component set. In some embodiments, the computer program code, in execution with at least one processor, configures the computer program product for generating, using a component reconfiguration model, component reconfiguration data for the component cluster. In some embodiments, the computer program code, in execution with at least one processor, configures the computer program product for initiating performance of one or more component reconfiguration actions based on the component reconfiguration data.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 illustrates an exemplary block diagram of an environment in which embodiments of the present disclosure may operate;

FIG. 2 illustrates an exemplary block diagram of an example apparatus that may be specially configured in accordance with one or more embodiments of the present disclosure;

FIG. 3 illustrates an architecture of an example component reconfiguration device in accordance with one or more embodiments of the present disclosure;

FIG. 4 illustrates an example interface in accordance with one or more embodiments of the present disclosure;

FIG. 5 illustrates a flowchart of an example method in accordance with one or more embodiments of the present disclosure;

FIG. 6 illustrates a flowchart of an example method in accordance with one or more embodiments of the present disclosure; and

FIG. 7 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with systems, apparatuses, methods, and computer program products for component reconfiguration. As would be understood by one skilled in the field to which this disclosure pertains, there are numerous example scenarios in which systems, apparatuses, methods, and computer program products for component reconfiguration are desirable.

In many applications, it may be desirable to use systems, apparatuses, methods, and computer program products for component reconfiguration. For example, it may be desirable to use systems, apparatuses, methods, and computer program products for component reconfiguration to modify and/or standardize components such that a component and/or an item that includes the component is more efficient, lighter, is standardized, and/or has greater functionality. As another example, it may be desirable to use systems, apparatuses, methods, and computer program products for component reconfiguration in order to streamline manufacturing operations of a component and/or an item that includes the component. As another example, it may be desirable to use systems, apparatuses, methods, and computer program products for component reconfiguration in order to implement a component and/or an item that includes the component in an environment in which it was not previously possible to implement the component and/or the item that includes the component.

Example solutions for component reconfiguration include using one or more databases and/or one or more computing devices to perform component reconfiguration. However, such example solutions are inefficient, reactive, and technically deficient. For example, such example solutions are inefficient because such example solutions do not use a staged model pipeline that includes a plurality of specifically configured models for performing particular functions of component reconfiguration. As a result, such example solutions cause computing devices and databases to suffer from high latency, consume excessive processing power, and consume excessive memory. As another example, such example solutions are reactive because such example solutions are unable to automatically implement component reconfiguration actions. In this regard, such example solutions are unable to automatically implement component reconfiguration actions, such as component reconfiguration actions that automatically cause a component manufacturing procedure to be modified. As another example, such example solutions are technically deficient because such example solutions are unable to generate multiple clustering parameter sets that each include component features associated with different clustering units. Accordingly, there is a need for systems, apparatuses, methods, and computer program products that are able to perform component reconfiguration in an efficient, a proactive, and a technically sufficient manner.

Thus, to address these and/or other issues related to such example solutions, example systems, apparatuses, methods, and computer program products for initiating performance of one or more component reconfiguration actions are disclosed herein. For example, an embodiment in this disclosure, described in greater detail below, includes a method that includes identifying a component set from component configuration data. In some embodiments, the component set comprises one or more components. In some embodiments, the method includes retrieving a component feature set. In some embodiments, the component feature set comprises one or more component features corresponding to a component configuration type. In some embodiments, the method includes generating a first clustering parameter set comprising a first subset of the component feature set. In some embodiments generating the first clustering parameter set comprises identifying one or more key component features in the component feature set. In some embodiments generating the first clustering parameter set comprises applying a key clustering unit to at least one of the one or more key component features in the component feature set. In some embodiments, the method includes generating, using the first clustering parameter set and a clustering model, a component cluster comprising a subset of the component set. In some embodiments, the method includes generating, using a component reconfiguration model, component reconfiguration data for the component cluster. In some embodiments, the method includes initiating performance of one or more component reconfiguration actions based on the component reconfiguration data. Accordingly, the systems, apparatuses, methods, and computer program products provided herein enable component reconfiguration in an efficient, a proactive, and a technically sufficient manner.

### Example Systems and Apparatuses

Embodiments of the present disclosure herein include systems, apparatuses, methods, and computer program products configured for initiating performance of one or more component reconfiguration actions. For example, embodiments of the present disclosure herein may include systems, apparatuses, methods, and computer program products configured for component reconfiguration using value engineering (VE)and/or component engineering (CE). In some embodiments, value engineering and/or component engineering includes facilitating the lifecycle management of an item and/or components of an item. It should be readily appreciated that the embodiments of the apparatus, systems, methods, and computer program product described herein may be configured in various additional and alternative manners in addition to those expressly described herein.

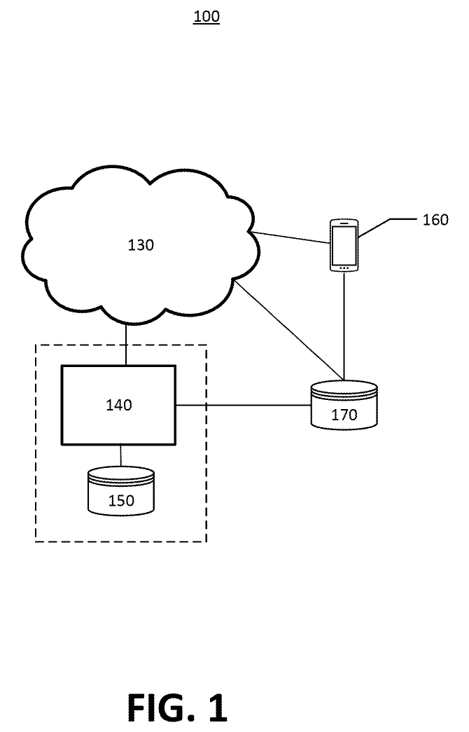

FIG. 1 illustrates an exemplary block diagram of an environment in which embodiments of the present disclosure may operate. In some embodiments, the environment 100 includes a component reconfiguration device 140. In some embodiments, the component reconfiguration device 140 is electronically and/or communicatively coupled to an internal component feature database 150, an external component feature database 170, and/or a user device 160. The component reconfiguration device 140 may be located remotely from the internal component feature database 150, the external component feature database 170, and/or the user device 160. In some embodiments, the component reconfiguration device 140 may be located in a remote cloud server and electronically and/or communicatively coupled to the internal component feature database 150, the external component feature database 170, and/or user device 160 via at least a network 130. In some embodiments, the component reconfiguration device 140 is configured via hardware, software, firmware, and/or a combination thereof, to perform data intake of one or more types of data, such as component configuration data, implementation data, component reconfiguration data, and/or the like.

Additionally, or alternatively, in some embodiments, the component reconfiguration device 140 is configured via hardware, software, firmware, and/or a combination thereof, to generate and/or transmit command(s) that control, adjust, or otherwise impact operations of the one or more of the internal component feature database 150, the external component feature database 170, the component reconfiguration device 140, and/or the user device 160. For example, the component reconfiguration device 140 may be configured to initiate performance of one or more component reconfiguration actions. Additionally, or alternatively, in some embodiments, the component reconfiguration device 140 is configured via hardware, software, firmware, and/or a combination thereof, to perform data reporting, provide data, and/or other data output process(es) associated with monitoring or otherwise analyzing operations of one or more of the one or more of the internal component feature database 150, the external component feature database 170, the component reconfiguration device 140, and/or the user device 160. For example, in various embodiments, the component reconfiguration device 140 may be configured to execute and/or perform one or more operations and/or functions described herein.

The user device 160 may be associated with users of the component reconfiguration device 140. In various embodiments, the component reconfiguration device 140 may generate and/or transmit a message, alert, or indication to a user via the user device 160. Additionally, or alternatively, the user device 160 may be utilized by a user to remotely access the component reconfiguration device 140. This may be by, for example, an application operating on the user device 160.

The external component feature database 170 may be configured to receive, store, and/or transmit data. In various embodiments, the external component feature database 170 may be associated with data associated with the component reconfiguration device 140, the internal component feature database 150, and/or the user device 160. Additionally, or alternatively, in some embodiments the external component feature database 170 stores user inputted data. The external component feature database 170 may be located remotely from the user device 160, the internal component feature database 150, and/or the component reconfiguration device 140, in proximity of the user device 160 and/or the component reconfiguration device 140, the internal component feature database 150, and/or within the user device 160, the internal component feature database 150, and/or the component reconfiguration device 140.

The internal component feature database 150 may be configured to receive, store, and/or transmit data. In various embodiments, the internal component feature database 150 may be associated with data associated with the component reconfiguration device 140, the external component feature database 170, and/or the user device 160. Additionally, or alternatively, in some embodiments the internal component feature database 150 stores user inputted data. The internal component feature database 150 may be located remotely from the user device 160, the external component feature database 170, and/or the component reconfiguration device 140, in proximity of the user device 160 and/or the component reconfiguration device 140, the external component feature database 170, and/or within the user device 160, the external component feature database 170, and/or the component reconfiguration device 140.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the component reconfiguration device 140 may include internal component feature database 150.

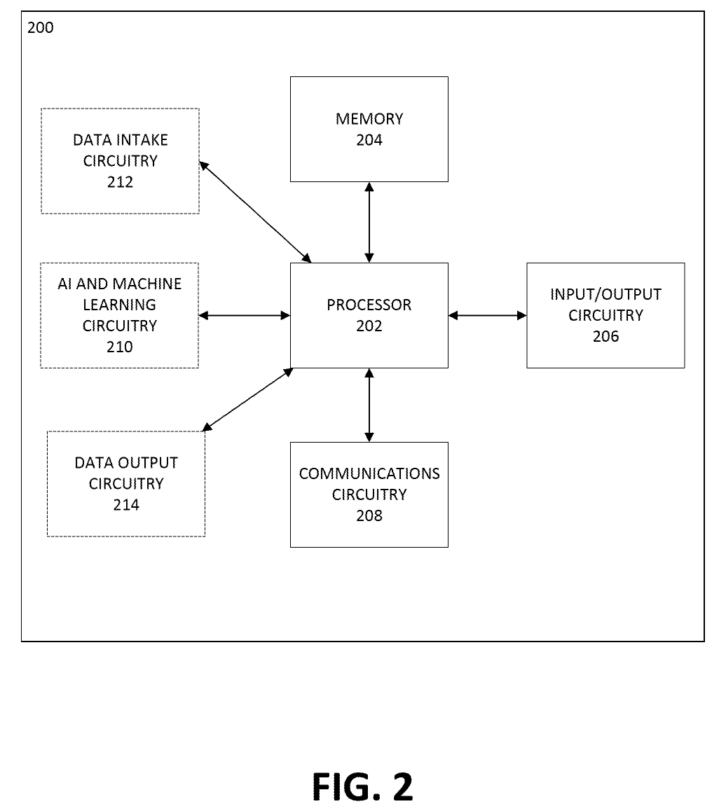

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. Examples of an apparatus 200 may include, but is not limited to, the internal component feature database 150, the component reconfiguration device 140, and/or the user device 160. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as an computing apparatus 200 of the internal component feature database 150, the external component feature database 170, the component reconfiguration device 140, and/or the user device 160 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuity 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the internal component feature database 150, the component reconfiguration device 140, and/or the user device 160. In some embodiments, the data intake circuitry 212 includes hardware, software, firmware, and/or a combination thereof, that communicates with one or more components of the internal component feature database 150, the external component feature database 170, the component reconfiguration device 140, and/or the user device 160 to receive particular data associated with such operations of the internal component feature database 150, the external component feature database 170, the component reconfiguration device 140, and/or the user device 160. The data intake circuitry 212 may support such operations for the internal component feature database 150, the component reconfiguration device 140, and/or the user device 160. Additionally, or alternatively, in some embodiments, the data intake circuitry 212 includes hardware, software, firmware, and/or a combination thereof, that retrieves particular data associated with the internal component feature database 150, the component reconfiguration device 140, the external component feature database 170, and/or the user device 160.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured to facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect the AI and machine learning circuitry 210.

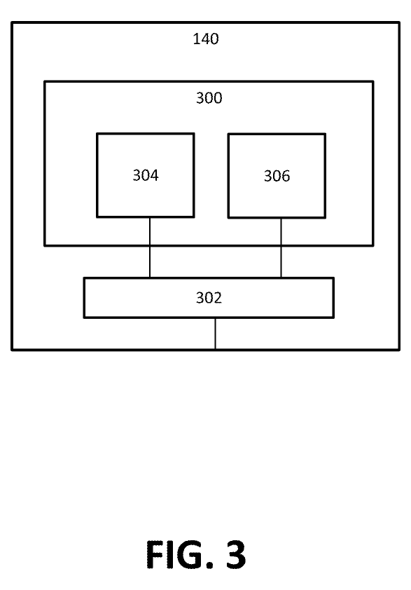

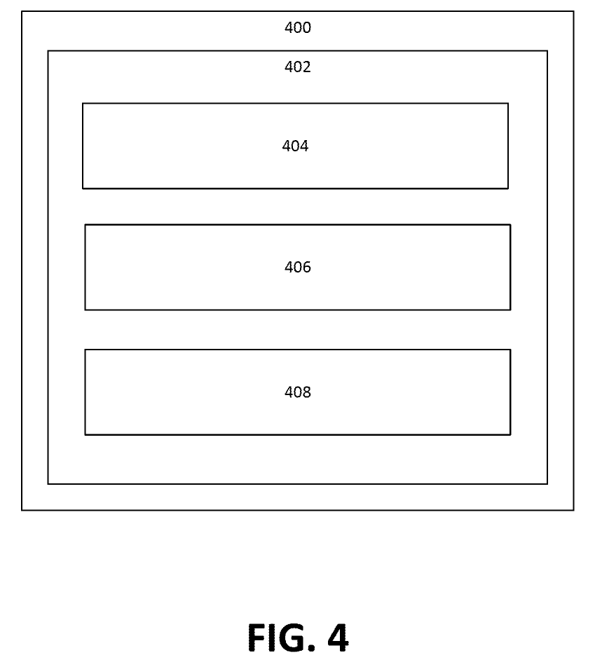

With reference to FIGS. 1-4, in some embodiments, the component reconfiguration device 140 is configured to the component reconfiguration device 140 is configured to identify component configuration data. In some embodiments, component configuration data includes one or more items of data representative and/or indicative of one or more components of an item. In this regard, for example, component configuration data may be representative and/or indicative of a bill of materials that lists one or more components, such as one or more components of an item. As another example, component configuration data may be representative and/or indicative of a structured dataset that is representative of a bill of materials associated with one or more components, such as one or more components of an item.

In some embodiments, an item includes an electrical item, a mechanical item, an electromechanical item, a resin item, a fastener item, a battery item, a monitor item (e.g., a liquid crystal display (LCD) item, a light emitting diodes (LED) display item, etc.), a display item (e.g., LCD item, a LED monitor item, etc.), a switch item, a relay item, an O-ring item, a metal item, a plastic item, a motor item, an enclosure item, a chemical item, a microcontroller item, and/or the like. For example, an item may include a printed circuit board (PCB), a printed circuit board assembly (PCBA), a sensor, a microcontroller, and/or the like. In some embodiments, an item may include one or more components that form a portion of the item. For example, an item may include an electrical component, a mechanical component, an electromechanical component, a resin component, a fastener component, a battery component, a monitor component (e.g., a liquid crystal display (LCD) component, a light emitting diodes (LED) display component, etc.), a display component (e.g., LCD component, a LED monitor component, etc.), a switch component, a relay component, an O-ring component, a metal component, a plastic component, a motor component, an enclosure component, a chemical component, a microcontroller component, and/or the like. For example, a component may include a printed circuit board (PCB), a printed circuit board assembly (PCBA), a sensor, a microcontroller, and/or the like.

In some embodiments, identifying component configuration data includes the component reconfiguration device 140 being configured to receive the component configuration data. For example, the component reconfiguration device 140 may be configured to receive component configuration data from the internal component feature database 150, the external component feature database 170, and/or the user device 160. Additionally, or alternatively, identifying component configuration data includes the component reconfiguration device 140 being configured to generate the component configuration data. For example, the component reconfiguration device 140 may be configured to generate component configuration data based on a bill of materials received by the component reconfiguration device 140.

In some embodiments, the component reconfiguration device 140 is configured to identify a component configuration type. In some embodiments, a component configuration type is representative and/or indicative of a particular type of component. For example, a component configuration type may be representative and/or indicative of a microcontroller component type. In some embodiments, the component reconfiguration device 140 is configured to identify a component configuration type by parsing component configuration data to identify the types of components represented in the component configuration data. For example, the component reconfiguration device 140 may be configured to parse component configuration data to identify a first component configuration type representative of one or more microcontroller components and a second component configuration type representative of one or more plastic components.

In some embodiments, the component reconfiguration device 140 is configured to identify a component set. In some embodiments, a component set is a collection of one or more components that are represented in component configuration data. For example, a component set may be a collection of one or more microcontroller components. In some embodiments, the component reconfiguration device 140 is configured to identify a component set from component configuration data. In this regard, in some embodiments, the component reconfiguration device 140 is configured to identify a component set that includes all of the components represented by component configuration data that are associated with a particular component configuration type. For example, the component reconfiguration device 140 may be configured to identify a component set that includes all of the microcontrollers represented by component configuration data that are associated with a microcontroller component configuration type.

In some embodiments, the component reconfiguration device 140 is configured to retrieve a component feature set. In some embodiments, a component feature set is a collection of one or more component features. In some embodiments, a component feature is a data object that is representative and/or indicative of a feature, characteristic, specification, report, schematic, and/or the like associated with a component.

In some embodiments, a component feature set includes one or more key component features. In this regard, in some embodiments, a key component feature is a data object that is representative and/or indicative of a feature, characteristic, parameter, specification, report, schematic, and/or the like associated with a component that is used to during an initial clustering processing associated with a component set. Additionally, or alternatively, a key component feature is a data object that is representative and/or indicative of a feature, characteristic, parameter, specification, report, schematic, and/or the like associated with a component that, if modified, prevents the component from being integrated into an item in which the component is currently a component of (e.g., the component is an essential feature of an item that the component is part of). For example, a key component feature may be one or more of a core architecture, a device core, a family name, a floating point unit, an instruction set architecture, and interface type, a process technology, a program memory type, a supplier temperature grade, a number of cores, a program memory size, a programmability of the component.

In some embodiments, a component feature set includes one or more secondary component features. In this regard a secondary component feature is a data object that is representative and/or indicative of a feature, characteristic, parameter, specification, report, schematic, and/or the like associated with a component that is used to during a secondary clustering processing associated with a component set. Additionally, or alternatively, a secondary component feature is a data object that is representative and/or indicative of a feature, characteristic, parameter, specification, report, schematic, and/or the like associated with a component that, if modified, does not prevent the component from being integrated into an item in which the component is currently a component of (e.g., the component is an optional feature of an item that the component is part of).

In some embodiments, a secondary component feature is an enclosure component feature. In some embodiments, an enclosure component feature is a data object that is representative and/or indicative of a feature, characteristic, parameter, specification, report, schematic, and/or the like that relates to an enclosure (e.g., packaging) in which a component is contained (e.g., during transport). For example, an enclosure component feature may be one or more of an enclosure configuration (e.g., a packaging of a component), a pin count, a mounting, an enclosure dimensions, an enclosure material, an enclosure case, a lead shape, an enclosure weight, an enclosure orientation, and/or the like associated with a component.

In some embodiments, a secondary component feature is a peripheral component feature. In some embodiments, a peripheral component feature is a data object that is representative and/or indicative of a feature, characteristic, parameter, specification, report, schematic, and/or the like that describes how a component is connected to and/or integrated with other components and/or items. For example, a peripheral component feature may be one or more of a number and/or type of analog-to-digital (ADC) channels, an ADC resolution, a number and/or type of analog comparators, a number and/or type of digital-to-analog (DAC) channels, a DAC resolution, a data bus width, a data cache size, a data memory size, a random access memory (RAM) size, a I2S/I2C/SPI/IART/ISART/CAN configuration, an instruction cache size, a maximum CPU frequency, a number and/or type of timers, a number and/or type of input/outputs (I/Os), and/or the like associated with a component.

In some embodiments, a secondary component feature is an operating component feature. In some embodiments, an operating component feature is a data object that is representative and/or indicative of a feature, characteristic, parameter, specification, report, schematic, and/or the like that describes how a component operates. For example, an operating component feature may be one or more of a typical operating supply voltage, a maximum operating supply voltage, a maximum operating temperature, a maximum storage temperature, a maximum power dissipation, a maximum operating supply voltage, a minimum operating temperature, a minimum storage temperature, an operating supply voltage, and/or the like associated with a component.

In some embodiments, the component reconfiguration device 140 is configured to retrieve a first portion of a component feature set from the internal component feature database 150. Additionally, or alternatively, the component reconfiguration device 140 is configured to retrieve a second portion of a component feature set from the external component feature database 170. In some embodiments, the component reconfiguration device 140 is configured to retrieve a component feature set in response to identifying a component set and/or a component configuration type.

In some embodiments, the component reconfiguration device 140 is configured to retrieve a component feature set based on a component configuration type. In this regard, in some embodiments, one or more component features in a component feature set may correspond to a component configuration type. Said differently, in some embodiments, the component reconfiguration device 140 is configured to identify a component set based on a component configuration type and then retrieve a component feature set that corresponds to the component configuration type that was used to identify the component set. For example, the component reconfiguration device 140 may be configured to identify a component set based on a microcontroller component configuration type (e.g., a component set of microcontrollers) and then retrieve a component feature set that corresponds to the microcontroller component configuration type (e.g., component features that correspond to the microcontrollers in the component set).

In some embodiments, the component reconfiguration device 140 is configured to generate a first clustering parameter set. In some embodiments, the first clustering parameter set includes a first subset of a component feature set. For example, the first clustering parameter set may include a portion of a component feature set retrieved by the component reconfiguration device 140.

In some embodiments, generating the first clustering parameter set includes the component reconfiguration device 140 being configured to identify one or more key component features in the component feature set. In this regard, in some embodiments, the first clustering parameter set includes one or more of the key component features in a component feature set. For example, the first clustering parameter set may include a key component feature representative of a core architecture associated with a component.

In some embodiments, generating the first clustering parameter set includes the component reconfiguration device 140 being configured to apply a key clustering unit to at least one of the one or more key component features in a component feature set (e.g., at least one of the identified key component features). In some embodiments, a key clustering unit is a weight assigned to a key component feature that is representative of the importance and/or influence of the key component feature during a clustering process. In some embodiments, a greater key clustering unit (e.g., a greater weight) is representative of a greater importance and/or influence of the key component feature during a clustering process.

In some embodiments, the component reconfiguration device 140 is configured to generate a second clustering parameter set. In some embodiments, the second clustering parameter set includes a second subset of a component feature set. For example, the second clustering parameter set may include a portion of a component feature set retrieved by the component reconfiguration device 140. In some embodiments, the second clustering parameter set may include a different portion of a component feature set than a first clustering parameter set.

In some embodiments, generating the second clustering parameter set includes the component reconfiguration device 140 being configured to identify one or more secondary component features in the component feature set. In this regard, in some embodiments, the second clustering parameter set includes one or more of the secondary component features in a component feature set. For example, the second clustering parameter set may include a secondary component feature representative of an enclosure (e.g., packaging) in which a component is contained (e.g., during transport).

In some embodiments, generating the second clustering parameter set includes the component reconfiguration device 140 being configured to apply a secondary clustering unit to at least one of the one or more secondary component features in a component feature set (e.g., at least one of the identified secondary component features). In some embodiments, the secondary clustering unit is a weight assigned to a secondary component feature that is representative of the importance and/or influence of the secondary component feature during a clustering process. In some embodiments, a greater secondary clustering unit (e.g., a greater weight) is representative of a greater importance and/or influence of the secondary component feature during a clustering process. In some embodiments, a key clustering unit is greater than a secondary clustering unit. In this regard, in some embodiments, a key component feature may have a greater importance and/or influence than a secondary component feature during a clustering process.

In some embodiments, the component reconfiguration device 140 is configured to generate a component cluster. In some embodiments, a component cluster includes a subset of a component set. For example, a component cluster may include a subset of a component set identified by the component reconfiguration device 140. In this regard, for example, a component cluster may include a subset of a collection of one or more microcontroller components.

In some embodiments, the component reconfiguration device 140 is configured to generate a component cluster using a first clustering parameter set and/or a clustering model 304. In this regard, in some embodiments, the clustering model 304 is configured to cluster a portion of the components from a component set into a component cluster. In some embodiments, the components clustered into the component cluster have similar and/or like key component features, such as key component features included in a first clustering parameter set. For example, the clustering model 304 may be configured to cluster microcontroller components into a microcontroller cluster when the microcontroller components have similar and/or like key component features, such as key component features included in a first clustering parameter set.

Additionally, or alternatively, the component reconfiguration device 140 is configured to generate a component cluster using a second clustering parameter set and/or the clustering model 304. In this regard, in some embodiments, the clustering model 304 is configured to cluster components from a component set into a component cluster. In some embodiments, the components clustered into the component cluster have similar and/or like secondary component features, such as secondary component features included in a second clustering parameter set. For example, the clustering model 304 may be configured to cluster microcontroller components into a microcontroller cluster when the microcontroller components have similar and/or like secondary component features, such as secondary component features included in a second clustering parameter set. In this regard, in some embodiments, the component reconfiguration device 140, using the clustering model 304, is configured to initially generate the component cluster using the first clustering parameter set and then further refine the component cluster using the second clustering parameter set. Additionally, or alternatively, the component reconfiguration device 140, using the clustering model 304, is configured to generate the competent cluster using the first clustering parameter set and the second clustering parameter set collaboratively (e.g., using the first clustering parameter set and the second clustering parameter set concurrently to generate the component cluster).

In some embodiments, the clustering model 304 may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate a component cluster. In this regard, in some embodiments, the clustering model 304 may be configured to utilize one or more of any type of machine learning, rules-based, and/or artificial intelligence techniques including one or more of clustering techniques (e.g., k-means techniques, expectation maximization techniques, centroid neural network techniques), computer vision techniques, supervised learning (e.g., using user feedback), unsupervised learning, semi-supervised learning, reinforcement learning, sequence modeling techniques, language processing techniques, neural network techniques, and/or generative artificial intelligence techniques. In some embodiments, the clustering model 304 is part of a staged model pipeline 300. For example, the clustering model 304 may be the first component of the staged model pipeline 300. In some embodiments, the staged model pipeline 300 is hosted and/or implemented by the component reconfiguration device 140.

In some embodiments, the component reconfiguration device 140 is configured to generate component reconfiguration data. In some embodiments, component reconfiguration data includes one or more items of data representative and/or indicative of one or more predicted standardizations associated with the component cluster. In this regard, in some embodiments, component reconfiguration data may be representative and/or indicative of one component in the component cluster to which all of the components in the component cluster may be standardized. Said differently, for example, the component reconfiguration device 140 may be configured to determine that the components in the component cluster have sufficiently similar key component features and/or secondary component features that one of the components in the component cluster may be implemented in all of the environments in which each of the components in the component cluster are currently implemented. For example, if the component cluster includes three components that are each used in a corresponding item, the component reconfiguration data may be representative and/or indicative of a first component of the three components to which the other two components may be standardized such that the first component may be used in each of the corresponding items.

In some embodiments, the component reconfiguration device 140 is configured to generate component reconfiguration data using a component reconfiguration model 306. In some embodiments, the component reconfiguration model 306 may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate a component cluster. In this regard, in some embodiments, the component reconfiguration model 306 may be configured to utilize one or more of any type of machine learning, rules-based, and/or artificial intelligence techniques including one or more of clustering techniques (e.g., k-means techniques, expectation maximization techniques, centroid neural network techniques), computer vision techniques, supervised learning (e.g., using user feedback), unsupervised learning, semi-supervised learning, reinforcement learning, sequence modeling techniques, language processing techniques, neural network techniques, and/or generative artificial intelligence techniques.

In some embodiments, the component reconfiguration model 306 is part of the staged model pipeline 300. For example, the component reconfiguration model 306 may be the second component of the staged model pipeline 300. In some embodiments, the component reconfiguration model 306 and the clustering model 304 are configured to communicate via a bus 302 of the staged model pipeline 300. In this regard, in some embodiments, the clustering model 304 and the component reconfiguration model 306 are configured to collaboratively work together to generate component reconfiguration data with the clustering model 304 being specifically configured to generate a component cluster and the component reconfiguration model 306 being specifically configured to generate component reconfiguration data. In this way, in some embodiments, by using the staged model pipeline 300, the component reconfiguration model 306 may be configured to generate a component cluster and component reconfiguration data that would not be possible using standalone models.

In some embodiments, the component reconfiguration device 140 is configured to initiate performance of one or more component reconfiguration actions. In some embodiments, the component reconfiguration device 140 is configured to initiate performance of one or more component reconfiguration actions based on component reconfiguration data, a component cluster, and/or the like. In this regard, in some embodiments, initiating performance of one or more component reconfiguration actions includes the component reconfiguration device 140 being configured to generate a component reconfiguration interface component 402. In some embodiments, the component reconfiguration interface component 402 includes a component reconfiguration interface element 404 configured to display component reconfiguration data. In some embodiments, the component reconfiguration interface component 402 includes an implementation interface element 406 configured to display implementation data. In some embodiments, the component reconfiguration interface component 402 includes a component visualization interface element 408 configured to display a visual representation of at least one component in a component cluster. For example, the component visualization interface element 408 may be configured to display a visual representation of a component in a component cluster to which all of the components in the component cluster may be standardized based on component reconfiguration data.

In some embodiments, initiating performance of component reconfiguration actions includes the component reconfiguration device 140 being configured to cause the component reconfiguration interface component 402 to be rendered to a component reconfiguration interface 400. In some embodiments, the component reconfiguration interface 400 may be provided on component reconfiguration device 140. Additionally, or alternatively, the component reconfiguration interface 400 may be provided on the user device 160. Additionally, or alternatively, the component reconfiguration interface 400 may be provided on one or more other devices, such as a remote device.

In some embodiments, initiating performance of one or more component reconfiguration actions includes the component reconfiguration device 140 being configured to cause a component inventory record to be updated. In some embodiments, a component inventory record is a record that indicates all of the components that may be included in a component cluster. In this regard, for example, a component inventory record may be updated to be associated with an indication that a component is being standardized to another component when component reconfiguration data is representative and/or indicative of the component being standardized to another component (e.g., the component will no longer be used). As another example, for example, a component inventory record may be updated to be associated with an indication that other components are being standardized to a particular component when component reconfiguration data indicates that other components in a component cluster will be standardized to the component (e.g., the component will not be used more frequently).

In some embodiments, initiating performance of one or more component reconfiguration actions includes the component reconfiguration device 140 being configured to transmit a component reconfiguration instruction to a computing device. For example, when a component inventory record is updated, the component reconfiguration device 140 may be configured to transmit a component reconfiguration instruction to a computing device indicating that new versions of the component will not be needed. As another example, when a component inventory record is updated to include additional orders for a component, the component reconfiguration device 140 may be configured to transmit a component reconfiguration instruction to a supplier computing device to place more orders for the component.

In some embodiments, initiating performance of one or more component reconfiguration actions includes the component reconfiguration device 140 being configured to cause an item manufacturing procedure to be modified. In some embodiments, an item manufacturing procedure is a series of steps that are performed to generate and/or create an item, such as item that includes a component in a component cluster. For example, an item manufacturing procedure may be a series of one or more manufacturing operations that are performed to generate and/or create an item. In this regard, in some embodiments, causing an item manufacturing procedure to be modified includes modifying an item manufacturing procedure to account for the standardization of the components in a component cluster. For example, if an item uses a component in a component cluster that component reconfiguration data indicates should be standardized to another component in the component cluster, an item manufacturing procedure for the item may be modified such that the item is manufactured using the standardized component.

In some embodiments, the component reconfiguration device 140 is configured to identify implementation data. In some embodiments, implementation data includes one or more items of data representative and/or indicative of current implementation of a component in a component cluster and/or an item that includes a component in a component cluster that component reconfiguration data indicates should be replaced with a standardized component (e.g., the standard component selected from a component cluster). For example, implementation data may be representative and/or indicative of demand for a component in a component cluster and/or an item that includes a component in a component cluster that component reconfiguration data indicates should be replaced with a standardized component. As another example, implementation data may be representative and/or indicative of inventory of a component in a component cluster and/or an item that includes a component in a component cluster that component reconfiguration data indicates should be replaced with a standardized component. As another example, implementation data may be representative and/or indicative of predicted orders for a component in a component cluster and/or an item that includes a component in a component cluster that component reconfiguration data indicates should be replaced with a standardized component.

In some embodiments, identifying implementation data includes the component reconfiguration device 140 being configured to receive the implementation data. For example, the component reconfiguration device 140 may be configured to receive implementation data from the internal component feature database 150. As another example, the component reconfiguration device 140 may be configured to receive implementation data from the external component feature database 170. Additionally, or alternatively, identifying implementation data includes the component reconfiguration device 140 being configured to generate the implementation data. For example, the component reconfiguration device 140 may be configured to generate implementation data based on historical implementation data. As another example, the component reconfiguration device 140 may be configured to generate implementation data based on a component cluster.

In some embodiments, the component reconfiguration device 140 is configured to determine an impact value associated with the component reconfiguration data based on implementation data. In some embodiments, an impact value is a data object representative and/or indicative of a cost, expenditure, resource consumption, value, and/or the like associated with standardizing one or more components in a component cluster in accordance with component reconfiguration data. In this regard, in some embodiments, an impact value may be determined by analyzing the demand for a component in a component cluster and/or an item that includes a component in a component cluster that component reconfiguration data indicates should be replaced with a standardized component. For example, if the demand for a component cluster and/or an item that includes a component in a component cluster that component reconfiguration data indicates should be replaced with a standardized component is below a demand threshold (e.g., the demand is low), the impact value may meet or exceed an impact value threshold (e.g., the impact value is high). As another example, if the demand for a component cluster and/or an item that includes a component in a component cluster that component reconfiguration data indicates should be replaced with a standardized component meets or exceeds a demand threshold (e.g., the demand is high), the impact value may be below an impact value threshold (e.g., the impact value is low).

In some embodiments, an impact value may be determined by analyzing the inventory for a component in a component cluster and/or an item that includes a component in a component cluster that component reconfiguration data indicates should be replaced with a standardized component. For example, if the inventory for a component cluster and/or an item that includes a component in a component cluster that component reconfiguration data indicates should be replaced with a standardized component is below an inventory threshold (e.g., the inventory is low), the impact value may be below an impact value threshold (e.g., the impact value is low). As another example, if the inventory for a component cluster and/or an item that includes a component in a component cluster that component reconfiguration data indicates should be replaced with a standardized component meets or exceeds an inventory threshold (e.g., the inventory is high), the impact value may meet or exceed an impact value threshold (e.g., the impact value is high).

In some embodiments, an impact value may be determined by analyzing the predicted orders for a component in a component cluster and/or an item that includes a component in a component cluster that component reconfiguration data indicates should be replaced with a standardized component. For example, if the predicted orders for a component cluster and/or an item that includes a component in a component cluster that component reconfiguration data indicates should be replaced with a standardized component is below a predicted orders threshold (e.g., the predicted orders are low), the impact value may meet or exceed an impact value threshold (e.g., the impact value is high). As another example, if the predicted orders for a component cluster and/or an item that includes a component in a component cluster that component reconfiguration data indicates should be replaced with a standardized component meets or exceeds a predicted orders threshold (e.g., the predicted orders are), the impact value may be below an impact value threshold (e.g., the impact value is low).

### Example Methods

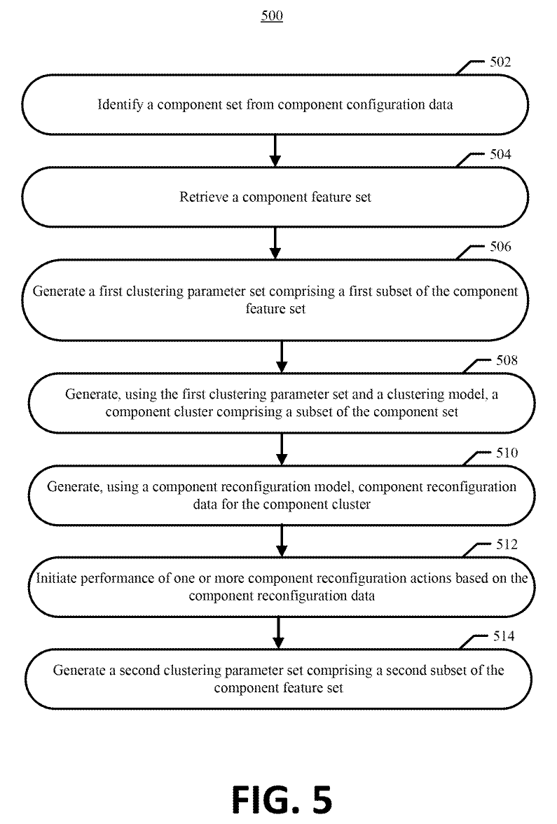

Referring now to FIG. 5, a flowchart providing an example method 500 is illustrated. In this regard, FIG. 5 illustrates operations that may be performed by the internal component feature database 150, the external component feature database 170, the component reconfiguration device 140, the user device 160, and/or the like. In some embodiments, the method 500 includes operations for generating component reconfiguration data and/or initiating performance of one or more component reconfiguration actions. In some embodiments, the example method 500 defines a process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 500.

As shown in block 502, the method 500 includes identifying a component set from component configuration data. As described above, in some embodiments, component configuration data includes one or more items of data representative and/or indicative of one or more components of an item. In this regard, for example, component configuration data may be representative and/or indicative of a bill of materials that lists one or more components, such as one or more components of an item. As another example, component configuration data may be representative and/or indicative of a structured dataset that is representative of a bill of materials associated with one or more components, such as one or more components of an item.

In some embodiments, an item includes an electrical item, a mechanical item, an electromechanical item, a resin item, a fastener item, a battery item, a monitor item (e.g., a liquid crystal display (LCD) item, a light emitting diodes (LED) display item, etc.), a display item (e.g., LCD item, a LED monitor item, etc.), a switch item, a relay item, an O-ring item, a metal item, a plastic item, a motor item, an enclosure item, a chemical item, a microcontroller item, and/or the like. For example, an item may include a printed circuit board (PCB), a printed circuit board assembly (PCBA), a sensor, a microcontroller, and/or the like. In some embodiments, an item may include one or more components that form a portion of the item. For example, an item may include an electrical component, a mechanical component, an electromechanical component, a resin component, a fastener component, a battery component, a monitor component (e.g., a liquid crystal display (LCD) component, a light emitting diodes (LED) display component, etc.), a display component (e.g., LCD component, a LED monitor component, etc.), a switch component, a relay component, an O-ring component, a metal component, a plastic component, a motor component, an enclosure component, a chemical component, a microcontroller component, and/or the like. For example, a component may include a printed circuit board (PCB), a printed circuit board assembly (PCBA), a sensor, a microcontroller, and/or the like.

In some embodiments, identifying component configuration data includes the component reconfiguration device 140 being configured to receive the component configuration data. For example, the component reconfiguration device 140 may be configured to receive component configuration data from the internal component feature database 150, the external component feature database 170, and/or the user device 160. Additionally, or alternatively, identifying component configuration data includes the component reconfiguration device 140 being configured to generate the component configuration data. For example, the component reconfiguration device 140 may be configured to generate component configuration data based on a bill of materials received by the component reconfiguration device 140.

In some embodiments, the component reconfiguration device 140 is configured to identify a component configuration type. In some embodiments, a component configuration type is representative and/or indicative of a particular type of component. For example, a component configuration type may be representative and/or indicative of a microcontroller component type. In some embodiments, the component reconfiguration device 140 is configured to identify a component configuration type by parsing component configuration data to identify the types of components represented in the component configuration data. For example, the component reconfiguration device 140 may be configured to parse component configuration data to identify a first component configuration type representative of one or more microcontroller components and a second component configuration type representative of one or more plastic components.

In some embodiments, the component reconfiguration device 140 is configured to identify a component set. In some embodiments, a component set is a collection of one or more components that are represented in component configuration data. For example, a component set may be a collection of one or more microcontroller components. In some embodiments, the component reconfiguration device 140 is configured to identify a component set from component configuration data. In this regard, in some embodiments, the component reconfiguration device 140 is configured to identify a component set that includes all of the components represented by component configuration data that are associated with a particular component configuration type. For example, the component reconfiguration device 140 may be configured to identify a component set that includes all of the microcontrollers represented by component configuration data that are associated with a microcontroller component configuration type.

As shown in block 504, the method 500 includes retrieving a component feature set. As described above, in some embodiments, a component feature set is a collection of one or more component features. In some embodiments, a component feature is a data object that is representative and/or indicative of a feature, characteristic, specification, report, schematic, and/or the like associated with a component.

In some embodiments, a component feature set includes one or more key component features. In this regard, in some embodiments, a key component feature is a data object that is representative and/or indicative of a feature, characteristic, parameter, specification, report, schematic, and/or the like associated with a component that is used to during an initial clustering processing associated with a component set. Additionally, or alternatively, a key component feature is a data object that is representative and/or indicative of a feature, characteristic, parameter, specification, report, schematic, and/or the like associated with a component that, if modified, prevents the component from being integrated into an item in which the component is currently a component of (e.g., the component is an essential feature of an item that the component is part of). For example, a key component feature may be one or more of a core architecture, a device core, a family name, a floating point unit, an instruction set architecture, and interface type, a process technology, a program memory type, a supplier temperature grade, a number of cores, a program memory size, a programmability of the component.

In some embodiments, a component feature set includes one or more secondary component features. In this regard a secondary component feature is a data object that is representative and/or indicative of a feature, characteristic, parameter, specification, report, schematic, and/or the like associated with a component that is used to during a secondary clustering processing associated with a component set. Additionally, or alternatively, a secondary component feature is a data object that is representative and/or indicative of a feature, characteristic, parameter, specification, report, schematic, and/or the like associated with a component that, if modified, does not prevent the component from being integrated into an item in which the component is currently a component of (e.g., the component is an optional feature of an item that the component is part of).

In some embodiments, a secondary component feature is an enclosure component feature. In some embodiments, an enclosure component feature is a data object that is representative and/or indicative of a feature, characteristic, parameter, specification, report, schematic, and/or the like that relates to an enclosure (e.g., packaging) in which a component is contained (e.g., during transport). For example, an enclosure component feature may be one or more of an enclosure configuration (e.g., a packaging of a component), a pin count, a mounting, an enclosure dimensions, an enclosure material, an enclosure case, a lead shape, an enclosure weight, an enclosure orientation, and/or the like associated with a component.

In some embodiments, a secondary component feature is a peripheral component feature. In some embodiments, a peripheral component feature is a data object that is representative and/or indicative of a feature, characteristic, parameter, specification, report, schematic, and/or the like that describes how a component is connected to and/or integrated with other components and/or items. For example, a peripheral component feature may be one or more of a number and/or type of analog-to-digital (ADC) channels, an ADC resolution, a number and/or type of analog comparators, a number and/or type of digital-to-analog (DAC) channels, a DAC resolution, a data bus width, a data cache size, a data memory size, a random access memory (RAM) size, a I2S/I2C/SPI/IART/ISART/CAN configuration, an instruction cache size, a maximum CPU frequency, a number and/or type of timers, a number and/or type of input/outputs (I/Os), and/or the like associated with a component.

In some embodiments, a secondary component feature is an operating component feature. In some embodiments, an operating component feature is a data object that is representative and/or indicative of a feature, characteristic, parameter, specification, report, schematic, and/or the like that describes how a component operates. For example, an operating component feature may be one or more of a typical operating supply voltage, a maximum operating supply voltage, a maximum operating temperature, a maximum storage temperature, a maximum power dissipation, a maximum operating supply voltage, a minimum operating temperature, a minimum storage temperature, an operating supply voltage, and/or the like associated with a component.

In some embodiments, the component reconfiguration device 140 is configured to retrieve a first portion of a component feature set from the internal component feature database 150. Additionally, or alternatively, the component reconfiguration device 140 is configured to retrieve a second portion of a component feature set from the external component feature database 170. In some embodiments, the component reconfiguration device 140 is configured to retrieve a component feature set in response to identifying a component set and/or a component configuration type.

In some embodiments, the component reconfiguration device 140 is configured to retrieve a component feature set based on a component configuration type. In this regard, in some embodiments, one or more component features in a component feature set may correspond to a component configuration type. Said differently, in some embodiments, the component reconfiguration device 140 is configured to identify a component set based on a component configuration type and then retrieve a component feature set that corresponds to the component configuration type that was used to identify the component set. For example, the component reconfiguration device 140 may be configured to identify a component set based on a microcontroller component configuration type (e.g., a component set of microcontrollers) and then retrieve a component feature set that corresponds to the microcontroller component configuration type (e.g., component features that correspond to the microcontrollers in the component set).

As shown in block 506, the method 500 includes generating a first clustering parameter set comprising a first subset of the component feature set. As described above, in some embodiments, the first clustering parameter set includes a first subset of a component feature set. For example, the first clustering parameter set may include a portion of a component feature set retrieved by the component reconfiguration device 140.

In some embodiments, generating the first clustering parameter set includes the component reconfiguration device 140 being configured to identify one or more key component features in the component feature set. In this regard, in some embodiments, the first clustering parameter set includes one or more of the key component features in a component feature set. For example, the first clustering parameter set may include a key component feature representative of a core architecture associated with a component.

In some embodiments, generating the first clustering parameter set includes the component reconfiguration device 140 being configured to apply a key clustering unit to at least one of the one or more key component features in a component feature set (e.g., at least one of the identified key component features). In some embodiments, a key clustering unit is a weight assigned to a key component feature that is representative of the importance and/or influence of the key component feature during a clustering process. In some embodiments, a greater key clustering unit (e.g., a greater weight) is representative of a greater importance and/or influence of the key component feature during a clustering process.

As shown in block 508, the method 500 includes generating, using the first clustering parameter set and a clustering model, a component cluster comprising a subset of the component set. As described above, in some embodiments, a component cluster includes a subset of a component set. For example, a component cluster may include a subset of a component set identified by the component reconfiguration device 140. In this regard, for example, a component cluster may include a subset of a collection of one or more microcontroller components.

In some embodiments, the component reconfiguration device 140 is configured to generate a component cluster using a first clustering parameter set and/or a clustering model 304. In this regard, in some embodiments, the clustering model 304 is configured to cluster a portion of the components from a component set into a component cluster. In some embodiments, the components clustered into the component cluster have similar and/or like key component features, such as key component features included in a first clustering parameter set. For example, the clustering model 304 may be configured to cluster microcontroller components into a microcontroller cluster when the microcontroller components have similar and/or like key component features, such as key component features included in a first clustering parameter set.

Additionally, or alternatively, the component reconfiguration device 140 is configured to generate a component cluster using a second clustering parameter set and/or the clustering model 304. In this regard, in some embodiments, the clustering model 304 is configured to cluster components from a component set into a component cluster. In some embodiments, the components clustered into the component cluster have similar and/or like secondary component features, such as secondary component features included in a second clustering parameter set. For example, the clustering model 304 may be configured to cluster microcontroller components into a microcontroller cluster when the microcontroller components have similar and/or like secondary component features, such as secondary component features included in a second clustering parameter set. In this regard, in some embodiments, the component reconfiguration device 140, using the clustering model 304, is configured to initially generate the component cluster using the first clustering parameter set and then further refine the component cluster using the second clustering parameter set. Additionally, or alternatively, the component reconfiguration device 140, using the clustering model 304, is configured to generate the competent cluster using the first clustering parameter set and the second clustering parameter set collaboratively (e.g., using the first clustering parameter set and the second clustering parameter set concurrently to generate the component cluster).

In some embodiments, the clustering model 304 may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate a component cluster. In this regard, in some embodiments, the clustering model 304 may be configured to utilize one or more of any type of machine learning, rules-based, and/or artificial intelligence techniques including one or more of clustering techniques (e.g., k-means techniques, expectation maximization techniques, centroid neural network techniques), computer vision techniques, supervised learning (e.g., using user feedback), unsupervised learning, semi-supervised learning, reinforcement learning, sequence modeling techniques, language processing techniques, neural network techniques, and/or generative artificial intelligence techniques. In some embodiments, the clustering model 304 is part of a staged model pipeline 300. For example, the clustering model 304 may be the first component of the staged model pipeline 300. In some embodiments, the staged model pipeline 300 is hosted and/or implemented by the component reconfiguration device 140.

As shown in block 510, the method 500 includes generating, using a component reconfiguration model, component reconfiguration data for the component cluster. As described above, in some embodiments, component reconfiguration data includes one or more items of data representative and/or indicative of one or more predicted standardizations associated with the component cluster. In this regard, in some embodiments, component reconfiguration data may be representative and/or indicative of one component in the component cluster to which all of the components in the component cluster may be standardized. Said differently, for example, the component reconfiguration device 140 may be configured to determine that the components in the component cluster have sufficiently similar key component features and/or secondary component features that one of the components in the component cluster may be implemented in all of the environments in which each of the components in the component cluster are currently implemented. For example, if the component cluster includes three components that are each used in a corresponding item, the component reconfiguration data may be representative and/or indicative of a first component of the three components to which the other two components may be standardized such that the first component may be used in each of the corresponding items.

In some embodiments, the component reconfiguration device 140 is configured to generate component reconfiguration data using a component reconfiguration model 306. In some embodiments, the component reconfiguration model 306 may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate a component cluster. In this regard, in some embodiments, the component reconfiguration model 306 may be configured to utilize one or more of any type of machine learning, rules-based, and/or artificial intelligence techniques including one or more of clustering techniques (e.g., k-means techniques, expectation maximization techniques, centroid neural network techniques), computer vision techniques, supervised learning (e.g., using user feedback), unsupervised learning, semi-supervised learning, reinforcement learning, sequence modeling techniques, language processing techniques, neural network techniques, and/or generative artificial intelligence techniques.

In some embodiments, the component reconfiguration model 306 is part of the staged model pipeline 300. For example, the component reconfiguration model 306 may be the second component of the staged model pipeline 300. In some embodiments, the component reconfiguration model 306 and the clustering model 304 are configured to communicate via a bus 302 of the staged model pipeline 300. In this regard, in some embodiments, the clustering model 304 and the component reconfiguration model 306 are configured to collaboratively work together to generate component reconfiguration data with the clustering model 304 being specifically configured to generate a component cluster and the component reconfiguration model 306 being specifically configured to generate component reconfiguration data. In this way, in some embodiments, by using the staged model pipeline 300, the component reconfiguration model 306 may be configured to generate a component cluster and component reconfiguration data that would not be possible using standalone models.

As shown in block 512, the method 500 includes initiating performance of one or more component reconfiguration actions based on the component reconfiguration data. In some embodiments, performance of one or more component reconfiguration actions is initiated in response to generation of component reconfiguration data.

As shown in block 514, the method 500 includes generating a second clustering parameter set comprising a second subset of the component feature set. As described above, in some embodiments, the second clustering parameter set includes a second subset of a component feature set. For example, the second clustering parameter set may include a portion of a component feature set retrieved by the component reconfiguration device 140. In some embodiments, the second clustering parameter set may include a different portion of a component feature set than a first clustering parameter set.

In some embodiments, generating the second clustering parameter set includes the component reconfiguration device 140 being configured to identify one or more secondary component features in the component feature set. In this regard, in some embodiments, the second clustering parameter set includes one or more of the secondary component features in a component feature set. For example, the second clustering parameter set may include a secondary component feature representative of an enclosure (e.g., packaging) in which a component is contained (e.g., during transport).

In some embodiments, generating the second clustering parameter set includes the component reconfiguration device 140 being configured to apply a secondary clustering unit to at least one of the one or more secondary component features in a component feature set (e.g., at least one of the identified secondary component features). In some embodiments, the secondary clustering unit is a weight assigned to a secondary component feature that is representative of the importance and/or influence of the secondary component feature during a clustering process. In some embodiments, a greater secondary clustering unit (e.g., a greater weight) is representative of a greater importance and/or influence of the secondary component feature during a clustering process. In some embodiments, a key clustering unit is greater than a secondary clustering unit. In this regard, in some embodiments, a key component feature may have a greater importance and/or influence than a secondary component feature during a clustering process.

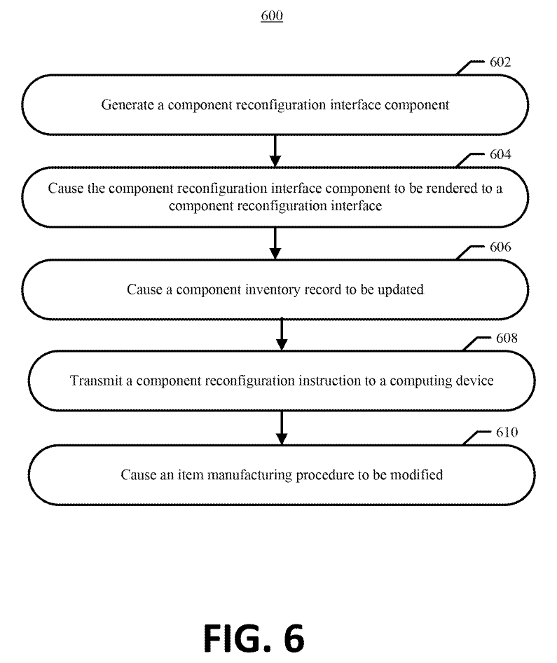

Referring now to FIG. 6, a flowchart providing an example method 600 is illustrated. In this regard, FIG. 6 illustrates operations that may be performed by the internal component feature database 150, the external component feature database 170, the component reconfiguration device 140, the user device 160, and/or the like. In some embodiments, the method 600 includes operations for initiating performance of one or more component reconfiguration actions. In some embodiments, the example method 600 defines a process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600.

As shown in block 602, the method 600 includes generating a component reconfiguration interface component. As described above, in some embodiments, the component reconfiguration interface component 402 includes a component reconfiguration interface element 404 configured to display component reconfiguration data. In some embodiments, the component reconfiguration interface component 402 includes an implementation interface element 406 configured to display implementation data. In some embodiments, the component reconfiguration interface component 402 includes a component visualization interface element 408 configured to display a visual representation of at least one component in a component cluster. For example, the component visualization interface element 408 may be configured to display a visual representation of a component in a component cluster to which all of the components in the component cluster may be standardized based on component reconfiguration data.

As shown in block 604, the method 600 includes causing the component reconfiguration interface component to be rendered to a component reconfiguration interface. As described above, in some embodiments, the component reconfiguration interface 400 may be provided on component reconfiguration device 140. Additionally, or alternatively, the component reconfiguration interface 400 may be provided on the user device 160. Additionally, or alternatively, the component reconfiguration interface 400 may be provided on one or more other devices, such as a remote device.

As shown in block 606, the method 600 includes causing a component inventory record to be modified. As described above, in some embodiments, a component inventory record is a record that indicates all of the components that may be included in a component cluster. In this regard, for example, a component inventory record may be updated to be associated with an indication that a component is being standardized to another component when component reconfiguration data is representative and/or indicative of the component being standardized to another component (e.g., the component will no longer be used). As another example, for example, a component inventory record may be updated to be associated with an indication that other components are being standardized to a particular component when component reconfiguration data indicates that other components in a component cluster will be standardized to the component (e.g., the component will not be used more frequently).

As shown in block 608, the method 600 includes transmitting a component reconfiguration instruction to a computing device. As described above, in some embodiments, when a component inventory record is updated, the component reconfiguration device 140 may be configured to transmit a component reconfiguration instruction to a computing device indicating that new versions of the component will not be needed. As another example, when a component inventory record is updated to include additional orders for a component, the component reconfiguration device 140 may be configured to transmit a component reconfiguration instruction to a supplier computing device to place more orders for the component.

As shown in block 610, the method 600 includes causing an item manufacturing procedure to be modified. As described above, in some embodiments, an item manufacturing procedure is a series of steps that are performed to generate and/or create an item, such as item that includes a component in a component cluster. For example, an item manufacturing procedure may be a series of one or more manufacturing operations that are performed to generate and/or create an item. In this regard, in some embodiments, causing an item manufacturing procedure to be modified includes modifying an item manufacturing procedure to account for the standardization of the components in a component cluster. For example, if an item uses a component in a component cluster that component reconfiguration data indicates should be standardized to another component in the component cluster, an item manufacturing procedure for the item may be modified such that the item is manufactured using the standardized component.

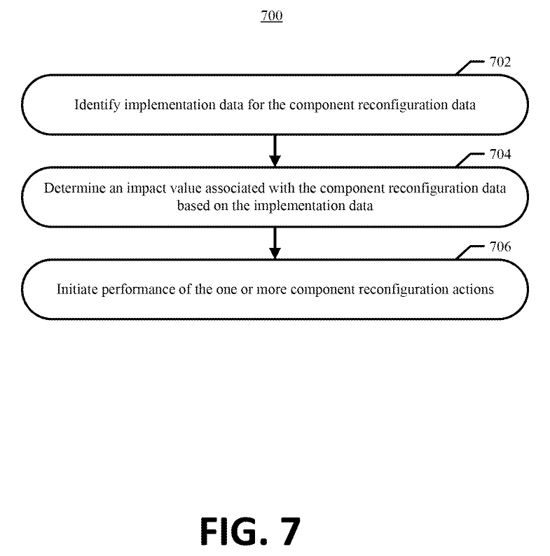

Referring now to FIG. 7, a flowchart providing an example method 700 is illustrated. In this regard, FIG. 7 illustrates operations that may be performed by the internal component feature database 150, the external component feature database 170, the component reconfiguration device 140, the user device 160, and/or the like. In some embodiments, the method 700 includes operations for determining an impact value associated with component configuration data based on implementation data. In some embodiments, the example method 700 defines a process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method 700 includes identifying implementation data for the component reconfiguration data. As described above, in some embodiments, implementation data includes one or more items of data representative and/or indicative of current implementation of a component in a component cluster and/or an item that includes a component in a component cluster that component reconfiguration data indicates should be replaced with a standardized component (e.g., the standard component selected from a component cluster). For example, implementation data may be representative and/or indicative of demand for a component in a component cluster and/or an item that includes a component in a component cluster that component reconfiguration data indicates should be replaced with a standardized component. As another example, implementation data may be representative and/or indicative of inventory of a component in a component cluster and/or an item that includes a component in a component cluster that component reconfiguration data indicates should be replaced with a standardized component. As another example, implementation data may be representative and/or indicative of predicted orders for a component in a component cluster and/or an item that includes a component in a component cluster that component reconfiguration data indicates should be replaced with a standardized component.

In some embodiments, identifying implementation data includes the component reconfiguration device 140 being configured to receive the implementation data. For example, the component reconfiguration device 140 may be configured to receive implementation data from the internal component feature database 150. As another example, the component reconfiguration device 140 may be configured to receive implementation data from the external component feature database 170. Additionally, or alternatively, identifying implementation data includes the component reconfiguration device 140 being configured to generate the implementation data. For example, the component reconfiguration device 140 may be configured to generate implementation data based on historical implementation data. As another example, the component reconfiguration device 140 may be configured to generate implementation data based on a component cluster.

As shown in block 704, the method 700 includes determining an impact value associated with the component reconfiguration data based on the implementation data. As described above, in some embodiments, an impact value is a data object representative and/or indicative of a cost, expenditure, resource consumption, value, and/or the like associated with standardizing one or more components in a component cluster in accordance with component reconfiguration data. In this regard, in some embodiments, an impact value may be determined by analyzing the demand for a component in a component cluster and/or an item that includes a component in a component cluster that component reconfiguration data indicates should be replaced with a standardized component. For example, if the demand for a component cluster and/or an item that includes a component in a component cluster that component reconfiguration data indicates should be replaced with a standardized component is below a demand threshold (e.g., the demand is low), the impact value may meet or exceed an impact value threshold (e.g., the impact value is high). As another example, if the demand for a component cluster and/or an item that includes a component in a component cluster that component reconfiguration data indicates should be replaced with a standardized component meets or exceeds a demand threshold (e.g., the demand is high), the impact value may be below an impact value threshold (e.g., the impact value is low).

In some embodiments, an impact value may be determined by analyzing the inventory for a component in a component cluster and/or an item that includes a component in a component cluster that component reconfiguration data indicates should be replaced with a standardized component. For example, if the inventory for a component cluster and/or an item that includes a component in a component cluster that component reconfiguration data indicates should be replaced with a standardized component is below an inventory threshold (e.g., the inventory is low), the impact value may be below an impact value threshold (e.g., the impact value is low). As another example, if the inventory for a component cluster and/or an item that includes a component in a component cluster that component reconfiguration data indicates should be replaced with a standardized component meets or exceeds an inventory threshold (e.g., the inventory is high), the impact value may meet or exceed an impact value threshold (e.g., the impact value is high).

In some embodiments, an impact value may be determined by analyzing the predicted orders for a component in a component cluster and/or an item that includes a component in a component cluster that component reconfiguration data indicates should be replaced with a standardized component. For example, if the predicted orders for a component cluster and/or an item that includes a component in a component cluster that component reconfiguration data indicates should be replaced with a standardized component is below a predicted orders threshold (e.g., the predicted orders are low), the impact value may meet or exceed an impact value threshold (e.g., the impact value is high). As another example, if the predicted orders for a component cluster and/or an item that includes a component in a component cluster that component reconfiguration data indicates should be replaced with a standardized component meets or exceeds a predicted orders threshold (e.g., the predicted orders are), the impact value may be below an impact value threshold (e.g., the impact value is low).

As shown in block 706, the method 700 includes initiating performance of the one or more component reconfiguration actions. In this regard, in some embodiments, performance of the one or more component reconfiguration actions is initiated in response to the impact value being below an impact value threshold.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
identifying a component set from component configuration data, wherein the component set comprises one or more components;
retrieving a component feature set, wherein the component feature set comprises one or more component features corresponding to a component configuration type;
generating a first clustering parameter set comprising a first subset of the component feature set, wherein generating the first clustering parameter set comprises:
identifying one or more key component features in the component feature set, and
applying a key clustering unit to at least one of the one or more key component features in the component feature set;
generating, using the first clustering parameter set and a clustering model, a component cluster comprising a subset of the component set;
generating, using a component reconfiguration model, component reconfiguration data for the component cluster; and
initiating performance of one or more component reconfiguration actions based on the component reconfiguration data.

2. The method of claim 1, further comprising:
generating a second clustering parameter set comprising a second subset of the component feature set.

3. The method of claim 2, wherein generating the second clustering parameter set comprises:
identifying one or more secondary component features in the component feature set, and
applying a secondary clustering unit to at least one of the one or more secondary component features in the component feature set.

4. The method of claim 3, wherein the one or more secondary component features comprise at least one of an enclosure component feature, a peripheral component feature, or an operating component feature.

5. The method of claim 2, wherein the component cluster is generated using the second clustering parameter set.

6. The method of claim 1, wherein a first portion of the component feature set is retrieved from an internal component feature database and a second portion of the component feature set is retrieved from an external component feature database.

7. The method of claim 1, wherein the clustering model and the component reconfiguration model communicate via a bus of a staged model pipeline.

8. The method of claim 1, further comprising:
identifying implementation data for the component reconfiguration data;
determining an impact value associated with the component reconfiguration data based on the implementation data; and
in response to the impact value being below an impact value threshold, initiating performance of the one or more component reconfiguration actions.

9. The method of claim 1, wherein initiating performance of the one or more component reconfiguration actions comprises:
generating a component reconfiguration interface component, wherein the component reconfiguration interface component comprises the component reconfiguration data, implementation data, or a visual representation of at least one component of the component cluster; and
causing the component reconfiguration interface component to be rendered to a component reconfiguration interface.

10. The method of claim 1, wherein initiating performance of the one or more component reconfiguration actions comprises:
causing a component inventory record to be updated.

11. The method of claim 1, wherein initiating performance of the one or more component reconfiguration actions comprises:
transmitting a component reconfiguration instruction to a computing device.

12. The method of claim 1, wherein initiating performance of the one or more component reconfiguration actions comprises:
causing an item manufacturing procedure to be modified.

13. An apparatus comprising memory and one or more processors communicatively coupled to the memory, the one or more processors configured to:
identify a component set from component configuration data, wherein the component set comprises one or more components;
retrieve a component feature set, wherein the component feature set comprises one or more component features corresponding to a component configuration type;
generate a first clustering parameter set comprising a first subset of the component feature set, wherein generating the first clustering parameter set comprises:
identifying one or more key component features in the component feature set, and
applying a key clustering unit to at least one of the one or more key component features in the component feature set;
generate, using the first clustering parameter set and a clustering model, a component cluster comprising a subset of the component set;
generate, using a component reconfiguration model, component reconfiguration data for the component cluster; and
initiate performance of one or more component reconfiguration actions based on the component reconfiguration data.

14. The apparatus of claim 13, wherein the one or more processors are further configured to:
generate a second clustering parameter set comprising a second subset of the component feature set.

15. The apparatus of claim 14, wherein generating the second clustering parameter set comprises:
identifying one or more secondary component features in the component feature set, and
applying a secondary clustering unit to at least one of the one or more secondary component features in the component feature set.

16. The apparatus of claim 15, wherein the one or more secondary component features comprise at least one of an enclosure component feature, a peripheral component feature, or an operating component feature.

17. The apparatus of claim 14, wherein the component cluster is generated using the second clustering parameter set.

18. The apparatus of claim 13, wherein a first portion of the component feature set is retrieved from an internal component feature database and a second portion of the component feature set is retrieved from an external component feature database.

19. The apparatus of claim 13, wherein the clustering model and the component reconfiguration model communicate via a bus of a staged model pipeline.

20. A computer program product comprising at least one non-transitory computer-readable storage medium having computer program code stored thereon that, in execution with at least one processor, configures the computer program product for:
identifying a component set from component configuration data, wherein the component set comprises one or more components;
retrieving a component feature set, wherein the component feature set comprises one or more component features corresponding to a component configuration type;
generating a first clustering parameter set comprising a first subset of the component feature set, wherein generating the first clustering parameter set comprises:
identifying one or more key component features in the component feature set, and
applying a key clustering unit to at least one of the one or more key component features in the component feature set;
generating, using the first clustering parameter set and a clustering model, a component cluster comprising a subset of the component set;
generating, using a component reconfiguration model, component reconfiguration data for the component cluster; and
initiating performance of one or more component reconfiguration actions based on the component reconfiguration data.
